(19) United States
(12) Patent Application Publication
(10) Pub. No.: US 2015/0099839 A1
(43) Pub. Date: Apr. 9, 2015

(54) THERMOPLASTIC MOLDING COMPOUNDS

(71) Applicant: LANXESS Deutschland GmbH, Cologne (DE)

(72) Inventors: Tobias Benighaus, Duesseldorf (DE); Detlev Joachimi, Krefeld (DE); Guenter Margraf, Dormagen (DE); Christian Ruthard, Mainz (DE); Holger Schmidt, Dormagen (DE)

(21) Appl. No.: 14/384,199

(22) PCT Filed: Mar. 18, 2013
(86) PCT No.: PCT/EP2013/055576

§ 371 Date: Dec. 15, 2014

(30) Foreign Application Priority Data
Mar. 21, 2012 (EP) 12160536.4

(51) Int. Cl. C08L 77/02; C08K 5/098; C09K 15/18; C08K 5/06

(52) U.S. Cl. CPC C08L 77/02; C08K 5/06; C08K 5/098; C09K 15/18; C08L 2201/08; C08L 2205/025
USPC 524/377; 252/400.53

(57) ABSTRACT

The present invention relates to a substance mixture comprising a combination of at least one salt of metal cations and of thermally activatable reducing anions and of at least one polyol, to the use of said substance mixture as stabilizer system for thermoplastic molding compositions or for fibers, foils, or moldings to be produced therefrom with respect to thermooxidative or photooxidative degradation, to a process for the production of said thermoplastic molding compositions, and to the fibers, foils, and moldings to be produced therefrom, and also in turn to uses of these.

The present invention relates to a substance mixture comprising a combination of at least one salt of metal cations and of thermally activatable reducing anions and of at least one polyol, to the use of said substance mixture as stabilizer system for thermoplastic molding compositions or for fibers, foils, or moldings to be produced therefrom with respect to thermooxidative or photooxidative degradation, to a process for the production of said thermoplastic molding compositions, and to the fibers, foils, and moldings to be produced therefrom, and also in turn to uses of these. Thermoplastic polymers, for example polyamides or polyesters, are frequently used as materials for moldings which during their lifetime have exposure to elevated temperatures over a prolonged period. A requirement here for many applications is that the materials have adequate stability with respect to the thermooxidative degradation that occurs here, and this applies in particular to applications in the engine compartment of motor vehicles.

Thermoplastic molding compositions and downstream products of these generally exhibit impairment of their mechanical properties when they are exposed for a prolonged period to elevated temperatures. This effect derives mainly from the oxidative degradation of the polymer at elevated temperatures (thermooxidative degradation). A prolonged period means for the purposes of the present invention a period longer than 100 hours, and elevated temperatures for the purposes of the present invention mean temperatures higher than SVC, in particular temperatures in the range from 180 to 200° C.

The stability of thermoplastic molding compositions and downstream products of these with respect to thermooxidative degradation is usually assessed by comparison of mechanical properties, in particular impact resistance, tensile stress at break and tensile strain at break measured in the tensile test in accordance with ISO 527, and also modulus of elasticity at defined temperature over a defined period.

Numerous systems for the stabilization of thermoplastic polymers, also termed thermoplastics, and also downstream products of these, with respect to thermooxidative degradation and the resultant molecular-weight decrease are known and have been described in the literature. A summary is found in “Plastic Additives Handbook” (5th Edition, Editor: Hans Zweifel, Carl Hamer Verlag, Munich 2001) on pages 10 to 19 and 40 to 92. Engineering thermoplastics, in particular polyamides, usually use, as organic stabilizers, antioxidants based on sterically hindered phenols or on aromatic amines, or, as inorganic stabilizers, systems based on copper compounds. The organic stabilizers mentioned are generally used for temperatures up to about 120° C., and some remain effective at higher temperatures.

Effective stabilization at higher temperatures up to about 140° C. is usually achieved by using stabilizer systems based on mixtures of copper halides and alkali metal halides.

In recent years, the requirements placed upon the service temperatures at which thermoplastic polymers such as polyamides remain sufficiently stable have become markedly more stringent. Many applications demand long-term heat stabilization with respect to thermooxidative degradation at 160° C. or even from 180 to 200° C.

DE-4305166 A1 describes improved copper-based thermal stabilization systems achieved by adding strong reducing agents; this leads to in-situ formation of finely dispersed elemental copper, DE-4305166 A1 moreover reveals that colloidal, elemental copper that is not produced in-situ has markedly less thermal stabilization activity.

U.S. Pat. No. 4,347,175 describes a process for the stabilization of polymers by mixing of the polymers with polyvalent metal formates and heating of the mixture to a temperature above the decomposition temperature of the polyvalent metal formates.

The use of polyols, also termed polyalcohols or polyhydric alcohols, in thermoplastic molding compositions, in particular based on polyamides, is described by way of example in EP1041109 A2. Here, polyols are used to improve flow in polyamide molding compositions.

DE 10 2004 019716 A also discloses a substance mixture comprising a polyol and a phosphinate as flame retardant for polyesters and polyamides.

WO 2009086035 A1 discloses a substance mixture comprising dipentaerythritol and a phosphinate as flame retardant for thermoplastic polyurethane.

WO 2006121549 A1 discloses a substance mixture comprising pentaerythritol or dipentaerythritol and a phosphinate as flame retardant for thermoplastic polyurethane.

Stabilizer systems can generally only retard, rather than prevent, the thermooxidative degradation of thermoplastic molding compositions, and also of downstream products of these, at elevated temperatures over a prolonged period. The requirements placed upon thermoplastic molding compositions and on moldings to be produced therefrom in high-temperature applications have not yet been adequately met by the systems known from the prior art: after ˜1000h of long-term aging at from 180 to 200° C., impact strength or tensile stress at break by way of example undergo a very marked reduction mostly to less than 50% of the initial value.

It was therefore an object of the present invention to provide a stabilizer system, and thermoplastic molding compositions comprising said stabilizer system, and thus permit marked improvement of stabilization with respect to thermooxidative degradation when comparison is made with the systems known from the prior art.

Surprisingly, it has now been found that a marked improvement in the stability of thermoplastics and of moldings to be produced therefrom with respect to thermooxidative degradation can be achieved by using the combination of at least one salt of metal cations and of thermally activatable reducing anions and of at least one polyol.

The object is achieved via the use, which is therefore provided by the present invention, of a combination of at least one salt of metal cations and of thermally activatable reducing anions and of at least one polyol for the stabilization of thermoplastic polymers or molding compositions based on thermoplastic polymers, and fibers, foils or moldings to be produced therefrom, with respect to thermooxidative degradation and/or photooxidative degradation, with the proviso that the molecular structure of the at least one polyol comprises at least two hydroxy groups, iron is used as metal cation, and formate or oxalate is used as thermally activatable reducing anion.

For clarification, it should be noted that the scope of the invention encompasses any desired combination of all of the definitions and parameters listed in general terms below or mentioned in preferred ranges.

The present application moreover provides substance mixtures, also termed stabilizer systems, comprising at least one salt of metal cations and of thermally activatable reducing anions and of at least one polyol, where the molecular structure of the at least one polyol comprises at least two hydroxy groups, and iron is used as metal cation, and formate or oxalate is used as thermally activatable reducing anion.

The present invention also provides thermoplastic molding compositions comprising
(1) from 10 to 99.75% by weight of a thermoplastic polymer or a combination of various thermoplastic polymers,
(2) from 0.05 to 10% by weight of at least one salt of metal cations and thermally activatable reducing anions,
(3) from 0.1 to 10% by weight of at least one polyol, where the molecular structure of the at least one polyol comprises at least two hydroxy groups, and
(4) from 0.1 to 70% by weight of additional substances, where the sum of the percentages by weight is always 100% by weight, with the proviso that iron is used as metal cation, and formate or oxalate is used as thermally activatable reducing anion.

In one preferred embodiment, the thermoplastic molding compositions of the invention also comprise, in addition to components (1) to (4), (5) from 5 to 70% by weight of fillers or reinforcing materials, preferably glass fibers or carbon fibers, particularly preferably glass fibers, where the proportions of components (1) to (4) are reduced in such a way that the sum of all of the percentages by weight is 100.

Preference is given in the invention to thermoplastic molding compositions comprising
(1) from 10 to 99.75% by weight of a thermoplastic polymer or of a combination of various thermoplastic polymers,
(2) from 0.05% to 8% by weight, preferably from 0.1 to 5% by weight, particularly preferably from 0.2 to 3% by weight, of at least one salt of metal cations and of thermally activatable reducing anions,
(3) from 0.1 to 8% by weight, preferably from 0.2 to 7% by weight, particularly preferably from 0.5 to 5% by weight, of at least one polyol, where the molecular structure of the at least one polypi comprises at least two hydroxy groups, and
(4) from 0.1 to 70% by weight of additional substances, where the sum of the percentages by weight is always 100% by weight, with the proviso that iron is used as metal cation, and formate or oxalate is used as thermally activatable reducing anion.

The present invention also provides the use of the thermoplastic molding compositions of the invention for the production of fibers, foils, or moldings of any type.

However, the present invention also provides a process for the thermal stabilization of thermoplastic polymers and of fibers, foils or moldings to be produced therefrom, by using a stabilizer system comprising at least one salt of metal cations and of thermally activatable reducing anions, and at least one polyol, where the molecular structure of the at least one polyol comprises at least two hydroxy groups, with the proviso that iron is used as metal cation and formate or oxalate is used as thermally activatable reducing anion.

The thermoplastic polymers to be used as component (1) are preferably amorphous polymers, thermoplastic elastomers, or semicrystalline polymers. It is particularly preferable to use the stabilizer system of the invention for polymers which are used in high-temperature applications, and it is very particularly preferable to use it for semicrystalline polymers, in particular for semicrystalline polymers with a melting point of at least 180° C., or amorphous polymers with a glass transition temperature of at least 150° C.

Amorphous polymers to be used in particular with particular preference as component (1) are amorphous polyamides, amorphous polyimides, amorphous polyetherimides, amorphous polysulfones, or amorphous polyarylates.

Semicrystalline polymers to be used in particular with particular preference as component (1) are polyphenylene sulfides, polyesters, polyether ketones, or semicrystalline polyamides.

In one preferred embodiment, a blend of various thermoplastic polymers is also used as component (1).

In particular, very particular preference is given to use of aliphatic or semiaromatic polyimide as component (1), in particular nylon-6 or nylon-6,6 with relative solution viscosities in m-cresol of from 2.0 to 4.0, and very particular preference is in particular given to use of raylon-6 with a relative solution viscosity in m-cresol of from 2.3 to 3.2.

Methods for determining relative solution viscosity measure the flow times of a dissolved polymer through an Ubbelohde viscometer in order then to determine the viscosity difference between polymer solution and its solvent, in this case m-cresol (1% solution). Standards that can be used are DIN 51562; DIN ISO 1628, or corresponding standards.

The blends to be used in one preferred embodiment preferably comprise, as component (1), nylon-6, nylon-6,6, nylon-4,6, nylon-12, or copolyamides. In an alternatively preferred embodiment, the blends comprise at least one of the polyamides mentioned and at least one other thermoplastic polymer from the group of polyphenylene oxide, polyethylene, and polypropylene.

The polyamides preferably to used in the thermoplastic molding compositions of the invention can be produced by various processes and are synthesized from various units. There are many known procedures for the production of polyamides, and in accordance with desired final product here use is made of various monomer units, various chain regulators for establishing a desired molecular weight, or else monomers having reactive groups for post-treatments subsequently envisaged.

The industrially significant processes for the production of the polyamides preferably to be used mostly proceed by way of polycondensation in the melt. For the purposes of the present invention, the hydrolytic polymerization of lactams is also understood to be polycondensation.

Polyamides preferred in the invention are semicrystalline polyamides which are produced by starting from diamines and dicarboxylic acids and/or from lactams having at least 5 ring members, or from corresponding amino acids. Starting materials that can be used are preferably aliphatic and/or aromatic dicarboxylic acids, particularly adipic acid, 2,2,4-trimethyladipic acid, 2,4,4-trimethyladipic acid, azelaic acid, sebacic acid, isophthalic acid, terephthalic acid, aliphatic and/or aromatic diamines, particularly preferably tetramethylenediamine, hexamethylenediamine, 2-methylpentane-1,5-diamine, 1,9-nonanediamine, 2,2,4- and 2,4,4-trimethythexamethylenediamine, the isomers diaminodicyclohexylmethane, diaminodicyclohexylproparte, bisaminomethylcyclohexane, phenylenediamine, xylylenediamine, aminocarboxylic acids, in particular aminocaproic acid, or the corresponding lactams. Copolyamides of a plurality of the monomers mentioned are included.

Polyamides particularly preferred in the invention are produced from caprolactam, very particularly preferably from ε-caprolactam.

In particular, preference is particularly given to most of the compounded materials based on PA6 and PA66, and to other compounded materials based on aliphatic or/and aromatic polyamides and, respectively, copolyamides, where there are from 3 to 11 methylene groups for each polyimide group in the polymer chain in all of said compounded materials.

Component (2) used comprises at least one salt of metal cations with thermally activatable reducing anions. The invention uses iron cations.

For the purposes of the invention, anions considered to be thermally activatable reducing anions are those which at temperatures of 100 to 450° C. preferably from 150 to 400° C., particularly preferably from 200 to 400° C., enter into reactions with a normal potential at 2.5° C. relative to the standard hydrogen electrode of less than 0 V, preferably less than −0.15 V, particularly preferably less than −0.3 V, with adequate reaction rate. For the purposes of this invention, reaction rates considered to be adequate reaction rates are those that lead to reaction of at least 10 mol %, preferably at least 25 mol %, particularly preferably at least 50 mol %, of the substance used, in this case the thermally activatable reducing anion, over a period of one hour.

Salts having fomate or oxalate anions are used in the invention, in particular salts having formate.

In one embodiment of the present invention, at least one formate is used as component (2).

In one embodiment of the present invention, at least one oxalate is used as component (2), Component (2) used particularly preferably comprises at least one salt of the group of iron oxalate and iron formate. In particular, iron formate is used as component (2). In particular, it is particularly preferable to use iron formate in which the iron cations are present in the oxidation states +2 or +3. In particular, it is very particularly preferable to use iron formate in which at least 50 mol %, in particular very particularly preferably at least 70 mol %, of the iron cations are present in the oxidation state +3.

Component (2) to be used in the invention is preferably used in the form of powder, paste, or compactate. The d₅₀ median particle size of preferred powders of component (2) is at most 1000 μm, preferably from 0.1 to 500 μm, particularly preferably from 0.5 to 250 μm (in accordance with ASTM D 1921-89, method A), and fine dispersion in the thermoplastic is thus ensured. If component (2) is used in the form of paste or compactate, it is possible to use the binders usually used for the production of pastes or compactates, these preferably being waxes, oils, polyglycols, or similar compounds, optionally also in combinations in suitable quantitative proportions.

The polyols to be used as components (3) in the invention are also known by the terms “polyalcohol” or “polyhydric alcohol”. The polyols to be used in the invention are organic molecules having at least two hydroxy groups per molecule. The polyol preferably has an aliphatic or aromatic structure or a combination of the two features.

In an alternatively preferred embodiment, the aliphatic chains within a polyol to be used in the invention comprise not only carbon atoms but also heteroatoms, preferably nitrogen, oxygen, or sulfur. In one preferred embodiment, the polyols to be used in the invention also have, alongside the hydroxy groups, other functional groups, preferably ether groups, carboxylic acid groups, amide groups, or ester groups.

Polyols which have more than two hydroxy groups and which are to be used with particular preference are those having three hydroxy groups from the group of glycerol, trimethylolpropane, 2,3-di(2′-hydroxyethyl)-cyclohexane-1-ol, hexane-1,2,6-triol, 1,1,1-tris(hydroxymethyl)ethane, 3-(2′-hydroxyethoxy)propane-1,2-diol, 3-(2′-hydroxypropoxy)propane-1,2-diol, 2-(2′-hydroxyethoxy)hexane-1,2-diol, 6-(2′-hydroxypropoxy)hexane-1,2-diol, 1,1,1-tris[(2′-hydroxyethoxy)methyl]ethane, 1,1,1-tris-2″-hydroxypropoxymethylpropane, 1,1,1-tris(4′-hydroxyphenyl)ethane, 1,1,1-tris(hydroxyphenyl)propane, 1,1,3-tris(dihydroxy-3-methylphenyl)propane, 1,1,4-tris(dihydroxyphenyl)butane, 1,1,5-tris(hydroxyphenyl)-3-methylpentane, ditrimethylolpropane, ethoxylates and propoxylates of tritnethylolproparte.

Particularly preferred polyols having more than three hydroxy groups are polyols from the group of D-mannitol, D-sorbitol, dulcitol, arabitol, inositol, xylitol, talitol, allitol, altritol, adonitol, erythritol, threitol, pentaerythritol, dipentaerythritol, and tripentaerythritol, and also polyols from the group of the monosaccharides, in particular mannose, glucose, galactose, fructose, D-xylose, arabinose, D-idose, D-erythrose, D-threose, D-ribose, D-lyxose, D-allose, D-altrose, D-gulose, D-talose, D-ribulose, D-erythrulose, D-xylulose, D-psicose, D-sorbose, D-tagatose, D-gluconic acid, D-saccharic acid, D-mannosaccharic acid, mucic acid, D-glucuronic acid, D-mannonic acid, ascorbic acid, D-glucosarctine, D-galactosamine.

Polyols to which particular preference is further given are those from the groups of the oligomeric or polymeric saccharides, in particular cyclodextrins, sucrose, lactose, trehalose, raffinose maltose, starch (amylose, amylopectin), pectins, chitin, glycogen, inulin, hemicellulose or cellulose.

Other polyols preferred in the invention and having more than three hydroxy groups are oligomeric or polymeric polyols where these are not from the saccharides group. In the invention, this comprises all or the oligomeric or polymeric polyols of any desired molecular weight which either hear, in one of their monomer units, one or more hydroxy groups that is retained after polymerization is complete, or else those oligomers or polymers that, in a step after the polymerization reaction, have been functionalized with hydroxy groups, preferably by a polymer-analogous reaction, in particular by saponification of esters. From these, it is in particular preferable to use polyester polyols, polyether polyols, phenol-formaldehyde resins (novolaks), polyvinyl alcohol, ethylene-vinyl alcohol copolymers (EVOH), or terpolymers of ethylene, of vinyl alcohol, and also of another compound having at least one double bond, preferably more than one double bond.

In particular, polyols to be used with particular preference as component (3) are those having more than three hydroxy groups. It is very particularly preferable to use at least one polyol from the group of pentaerythritol, dipentaerythritol, tripentaerythritol, ditrimethylolproparte, and ethylene-vinyl alcohol copolymers, and in particular dipentaerythritol or tripentaerythritol are particularly preferred, and in particular tripentaerythritol is very particularly preferred.

Other additional substances as component (4) for the purposes of the present invention are preferably substances from the group of thermal stabilizers not covered by the definition of the stabilizer system to be used in the invention, UV stabilizers, gamma-radiation stabilizers, hydrolysis stabilizers, antistatic agents, emulsifiers, nucleating agents, plasticizers, processing aids, impact modifiers, lubricants, mold-release agents, dyes, and pigments. The additives mentioned and other suitable additives are prior art and can be found by the person skilled in the art by way of example in Plastics Additives Handbook, 5th Edition, Hanser-Verlag, Munich, 2001, pp. 80-84, 546-547, 688, 872-874, 938, 966. The additional substances to be used as component (4) can be used alone or in a mixture or in the form of masterbatches.

Additional thermal stabilizers preferably to be used as additional substance in the invention and not covered by the abovementioned definition of the stabilizer system to be used in the invention are copper compounds, in particular copper halides in combination with alkali metal halides, alkali metal halides and alkaline earth metal halides, preferably sodium chloride or calcium chloride, manganese chloride, sterically hindered phenols and/or phosphites, phosphates, preferably disodium dihydrogendiphosphate, hydroquinones, aromatic secondary amines, in particular diphenylamines, substituted resorcinols, salicylates, benzotriazoles, or benzophenones, and also variously substituted representatives of these groups and/or mixtures of these.

UV stabilizers preferably to be used as additional substance in the invention are substituted resorcinols, salicylates, benzotriazoles, benzophenones.

Impact modifiers or elastomer modifiers preferably to be used in the invention as component (4) are very generally copolymers preferably composed of at least two from the following group of monomers: ethylene, propylene, butadiene, isobutane, isoprene, chloroprene, vinyl acetate, styrene, acrylonitrile, and acrylates or methacrylates having from 1 to 18 carbon atoms in the alcohol component. The copolymers can comprise compatibilizing groups, preferably maleic anhydride or epoxide.

Dyes or pigments preferably to be used as additional substance in the invention are inorganic pigments, particularly preferably titanium dioxide, ultramarine blue, iron oxide, zinc sulfide, or carbon black, and also organic pigments, particularly preferably phthalocyanines, quinacridones, perylenes, and also dyes, particularly preferably nigrosin or anthraquinone, as colorants, and also other colorants.

Nucleating agents preferably to be used as additional substance in the invention are sodium phenylphosphonate or calcium phenylphosphonate, aluminum oxide, or silicon dioxide, or talc powder, particularly preferably talc powder.

Lubricants and/or mold-release agents preferably to be used as additional substance in the invention are long-chain fatty acids, in particular stearic acid, salts thereof. In particular Ca stearate or Zn stearate, and also the ester or amide derivatives thereof, in particular ethylenebisstearylamide, glycerol tristearate, stearyl stearate, montan waxes, in particular esters of manta n waxes with ethylene glycol, and also low-molecular-weight polyethylene waxes and, respectively, low-molecular-weight polypropylene waxes in oxidized and non-oxidized form. Particularly preferred lubricants and/or mold-release agents in the invention are those within the group of the esters or amides of saturated or of unsaturated aliphatic carboxylic acids having from 8 to 40 C. atoms with saturated. Aliphatic alcohols or amines having from 2 to 40 C atoms. In another preferred embodiment, the molding compositions of the invention comprise mixtures of the abovementioned lubricants and/or mold-release agents.

For the purposes of the present invention, fillers and reinforcing materials as component (5) are fibrous, acicular, or particulate fillers and corresponding reinforcing materials. Preference is given to carbon fibers, glass beads, amorphous silica, calcium silicate, calcium metasilicate, magnesium carbonate, kaolin, calcined kaolin, chalk, quartz powder, mica, phlogopite, barium sulfate, feldspar, wollastonite, montmorillonite, or glass fibers, particularly preferably glass fibers, with particular preference glass fibers made of E glass. In one preferred embodiment, in order to provide better compatibility with thermoplastics, the fibrous or particulate reinforcing materials have suitable surface modifications, in particular surface modifications comprising silane compounds.

The present invention further provides a process for the production of the thermoplastic molding compositions of the invention, characterized in that components (1) to (4), and also optionally (5) are mixed in appropriate proportions by weight. It is preferable that the components are mixed at temperatures of from 220 to 400° C. by combining the components or by subjecting all of them to a mixing, kneading, compounding, extrusion, or rolling process, particular preference being given to compounding in a corotating twin-screw extruder or Buss kneader.

It can be advantageous to premix individual components. In one preferred embodiment, the molding compositions of the invention are produced in a two-stage process. In the first step, component (2) is mixed with a thermoplastic polymer to give a premix and heated to a temperature above the decomposition temperature of component (2). It is also possible in this step to mix other components of the thermoplastic molding composition of the invention with component (2) and with a thermoplastic polymer. It is preferable to carry out this step in a corotating twin-screw extruder, Buss kneader, or planetary-roll extruder.

In this first step, it is preferable that component (2) is reacted in a polyimide, preferably PA6 or PA66, with a relative solution viscosity in m-cresol of from 2.8 to 5,0, preferably from 3.5 to 45.

It is preferable that in this first step the premix made of thermoplastic and component (2), and also optionally other components, is heated to a temperature of from 300 to 400° C., particularly from 320 to 390° C., very particularly from 330 to 380° C..

In one preferred embodiment, the premix in the first step comprises not only the thermoplastic and component (2) but also at least one processing stabilizer. Processing stabilizer used preferably comprises sterically hindered phenols and/or phosphites, phosphates, hydroquinones, aromatic secondary amines, in particular diphenylamines, substituted resorcinols, salicylates, benzotriazoles, or benzophenones, or else variously substituted representatives of these groups and/or mixtures of these.

The proportion of component (2) in the premix in the first step is preferably from 1 to 60% by weight, particularly preferably from 1 to 30% by weight, very particularly preferably from 2 to 20% by weight. It is preferable that the premix is reacted in a twin-screw extruder, Buss kneader, or planetaryroll extruder equipped with a devolatilizing function, in order to remove the gaseous components that arise during the reaction of component (2).

Alternatively, component (2) can be reacted in a suitable substance of components (3) or (4) in a twin-screw extruder, Buss kneader, or other apparatus suitable for heating the mixture to temperatures above the decomposition temperature of component (2). It is also possible in the first step to use a batch process, for example in a stirred autoclave.

In an alternative preferred embodiment, component (2) is used in combination with one or more compounds which increase the reaction rate of component (2). The reaction of component (2) can thus be achieved at lower temperatures. Compounds of this type, also termed activators, are described by way of example in U.S. Pat. No. 4,438,223, the entire content of which is incorporated into the present invention. It is preferable to use, as activator, at least one compound from the group of sodium or potassium hydrogencarbonate, sodium or potassium acetate, sodium or potassium carbonate, sodium or potassium chloride, sodium or potassium bromide, sodium or potassium iodide, sodium or potassium rhodanide, or sodium or potassium benzoate.

In the second step, the premix from the first step is mixed with the remaining components of the thermoplastic molding composition of the invention in accordance with the processes described above. The thermoplastic molding compositions to be produced in the invention can be processed in accordance with processes known to the person skilled in the art, in particular by injection molding, extrusion, or blow molding. It can be advantageous to produce moldings or semifinished products directly from a physical mixture known as a dryblend produced at room temperature, preferably from 0 to 40° C., comprising premixed components and/or comprising individual components.

The downstream products to be produced in the invention from the molding compositions, in particular moldings, can preferably be used in the motor vehicle industry, electrical industry, electronics industry, telecommunications industry, solar industry, information-technology industry, computer industry, in the household, in sports, in medicine, or in the consumer-electronics industry. In particular, molding compositions of the invention can be used for applications which require high resistance to heat-aging. For applications of this type, preference is given to the use for moldings in vehicles, in particular in motor vehicles (MVs), in particular in the engine compartment of MVs.

The present invention therefore also provides the use of thermoplastic molding compositions comprising the stabilizer system to be used in the invention for the production of moldings and items with increased stability with respect to thermooxidative degradation, preferably of moldings for motor vehicles (MVs), with particular preference for the engine compartment of MVs. The thermoplastic molding compositions of the invention are moreover also suitable- for applications and, respectively, moldings or items where requirements are not only thermooxidative stability but also stability with respect to photooxidativer degradation, preferably solar systems.

Substance mixtures preferred in the invention comprise salts having metal cations of the transition metals of groups 8 to 10 of the periodic table of the elements, preferably salts having copper cations or having iron cations, particularly preferably salts having iron cations.

Substance mixtures of the invention comprise iron formate or iron oxalate as salt, in particular iron formate.

Substance mixtures preferred in the invention comprise at least one polyol from the group of glycerol, trimethylolpropane, 2,3-di(2″-hydroxyethyl)-cyclohexan-1-ol, hexane-1,2,6-triol, 1,1,1-tris(hydroxymethyl)ethane, 3-(2′-hydroxyethoxy)propane-1,2-diol, 3(2″-hydroxypropoxy)propane-1,2-diol, 2-(2′-hydroxyethoxy)hexane- 1,2-diol, 6-(2°-hydroxypropoxy)hexane-1,2-diol, 1,1,1-tris[(2′-hydroxyethoxy)methyl]ethane, 1,1,1-tris-2′-hydroxypropoxy methylpropane, 1,1,1-tris(4′-hydroxyphenyl)ethane, 1,1,1-tris(hyroxyphenyl)propane, 1,1,3-tris(dihydroxy-3-methylphenyl)propane, 1,1,4-tris(dihydroxyphenyl)butane, 1,1,5-tris(hydroxyphenyl)-3-methylpentane, ditrimethylolpropane, ethoxylates and propoxylates of trimethylolpropane, or from the group of D-mannitol, D-sorbitan, dulcitol, arabitol, inositol xylitol, talitol, allitol, altritol, adonitol, erythritol, threitol, pentaerythritol, dipentaerythritol, and tripentaerythritol, or else polyols from the group of the monosaccharides, in particular mannose, glucose, galactose, fructose, D-xylose, arabinose, D-idose, D-erythrose, D-threose, f)-ribose, D-lyxose, D-allose, D-altrose, D-gulose, D-talose, D-ribulose, D-erythrulose, D-xylulose, D-psicose, D-sorbose, D-tagatose, D-gluconic acid, D-saccharic acid, D-mannosaccharic acid, mucic acid, D-glucuronic acid, D-mannonic acid, ascorbic acid, D-glucosamine, D-galactosamine, or from the groups of the oligomeric or polymeric saccharides, in particular cyclodextrins, sucrose, lactose, trehalose, raffinose maltose, starch (amylose, amylopectin), pectins, chitin, glycogen, inulin, hemicellulose or cellulose, or else oligomeric or polymeric polyols where these are not from the saccharides group.

Particularly preferred substance mixtures in the invention comprise at least one polyol from the group of pentaerythritol, dipentaerythritol, tripentaerythritol, ditrimethylolpropane, and ethylene-vinyl alcohol copolymers, preferably dipentaerythritol or tripentaerythritol, particularly preferably tripentaerythritol.

Very particularly preferred substance mixtures in the invention comprise iron formate and dipentaerythritol and/or tripentaerythritol, with particular preference iron formate and dipentaerythritol, or iron formate and tripentaerythritol. In particular, the substance mixture is very particularly preferably composed of iron formate and dipentaerythritol, or of iron formate and tripentaerythritol. However, the present invention also provides the use of the substance mixtures of the invention for the prevention of thermooxidative degradation or photooxidative degradation of thermoplastic molding compositions, or of fibers, foils, or moldings to be produced therefrom.

The invention further provides the use of the fibers, foils, or moldings to be produced in the invention for the production of items for the electrical, electronics, telecommunications, information-technology, solar, or computer industry, for the household, for sports, for medical applications, or for the consumer-electronics industry, particularly preferably for motor vehicles, very particularly preferably for the engine compartment of motor vehicles.

However, the present application also provides a process for the reduction of photooxidative and/or thermooxidative degradation of thermoplastic polymers or of molding compositions to be produced therefrom, or of foils, fibers, or moldings to be produced therefrom by adding the stabilizer system or, respectively, substance mixture of the invention to the thermoplastic polymer.

However, the present application also provides a process for the reduction of photooxidative and/or thermooxidative degradation of semicrystalline polyamides or of molding compositions to be produced therefrom, or of foils, fibers, or moldings to be produced therefrom by adding the stabilizer system or, respectively, substance mixture of the invention to the semicrystalline polyamides.

### EXAMPLES

In order to demonstrate the advantages of the molding compositions of the invention, iron formate was first synthesized, and thermoplastic molding compositions which comprised said iron formate were then produced.

Synthesis of Iron Formate

197 g of sodium formate were dissolved in 500 ml of 30% formic acid. 235 g of iron(III) chloride were dissolved in 120 ml of distilled water. The aqueous solution of iron(III) chloride was then slowly added dropwise to the solution of sodium formate in formic acid. During the addition, the solution was stirred. Iron formate formed an orange precipitate. The suspension was stirred at room temperature for 3 h, and the product was subjected to filtration and washed with 30% formic acid. The residue was dried to constant weight.

Production of a Premix with 5% of iron Formate

5% by weight of the iron formate synthesized previously were mixed with 95% by weight of a polyimide PA6 A in a ZSK 26 Compounder twin-screw extruder from Coperion Werner & Pfleiderer (Stuttgart, Germany) at a temperature of about 370° C., discharged in the form of strand into a water bath, cooled until pelletizable, and pelletized. The pellets were dried in a vacuum drying oven for two days at 70° C.

Production of the Thermoplastic Molding Compositions with use of the Premix

The individual components were mixed at a temperature of about 280° C. in a ZSK 26 Compounder twin-screw extruder from Coperion Werner & Pfleiderer (Stuttgart, Germany), discharged in the form of strand into a water bath, cooled until pelletizable, and pelletized. The pellets were dried in a vacuum drying oven for two days at 70° C.

TABLE 1
Constitutions of the molding compositions produced with
use of the premix (all data in % by weight).

| Ingredient | Comp. ex. 1 | Inv. ex. 1 |
|---|---|---|
| Glass fiber | 30.000 | 30.000 |
| PA6 B | 69.680 | 56.820 |
| Microtalc powder | 0.020 | 0.020 |
| Montan ester wax | 0.160 | 0.160 |
| Potassium bromide | 0.100 | |
| Copper(I) iodide | 0.040 | |
| Premix of 5% of iron | | 10.000 |
| formate in PA6 A | | |
| Dipentaerythritol | | 3.000 |

TABLE 2
Tensile stress at break and tensile strain at break of the
molding compositions prior to and after heat-aging at
180 and 200° C.

| | Comp. | Inv. |
|---|---|---|
| | ex. 1 | ex. 1 |
| Tensile stress at break prior to heat-aging [MPa] | 179 | 183 |
| Tensile strain at break prior to heat-aging [%] | 3.8 | 3.3 |
| Tensile stress at break after 840 h at 180° C. [MPa] | 155 | 190 |
| Tensile strain at break after 840 h at 180° C. [%] | 1.8 | 2.3 |
| Tensile stress at break after 2016 h at 180° C. [MPa] | 148 | 190 |
| Tensile strain at break after 2016 h at 180° C. [%] | 1.6 | 2.4 |
| Tensile stress at break after 3024 h at 180° C. [MPa] | 137 | 190 |
| Tensile stress at break after 3024 h at 180° C. [MPa] | 1.6 | 2.6 |
| Tensile stress at break after 840 h at 200° C. [MPa] | 145 | 210 |
| Tensile strain at break after 840 h at 200° C. [%] | 1.6 | 1.8 |
| Tensile stress at break after 2016 h at 200° C. [MPa] | 77 | 195 |
| Tensile strain at break after 2016 h at 200° C. [%] | 0.9 | 2.5 |
| Tensile stress at break after 3024 h at 200° C. [MPa] | 16 | 181 |
| Tensile strain at break after 3024 h at 200° C. [%] | 0.3 | 2.2 |

Production of the Thermoplastic Molding Compositions without use of the Premix

Molding compositions of the invention were moreover produced without use of the premix described above. For this, the individual components were mixed at a temperature of about 320° C. in a ZSK 26 Compounder twin-screw extruder from Coperion Werner & Pfleiderer (Stuttgart, Germany), discharged in the form of strand into a water bath, cooled until pelletizable, and pelletized. The pellets were dried in a vacuum drying oven for two days at 70° C.

TABLE 3
Constitutions of the molding compositions produced
without premix (all data in % by weight).

| Ingredient | Comp. ex. 2 | Inv. ex. 2 | Inv. ex. 3 | Inv. ex. 4 |
|---|---|---|---|---|
| Glass fiber | 30.000 | 30.000 | 30.000 | 30.000 |
| PA6 B | 69.680 | 68.18 | 68.18 | 68.18 |
| Microtalc powder | 0.020 | 0.020 | 0.020 | 0.020 |
| Montan ester wax | 0.160 | 0.160 | 0.160 | 0.160 |
| Potassium bromide | 0.100 | 0.100 | 0.100 | 0.100 |
| Copper(I) iodide | 0.040 | 0.040 | 0.040 | 0.040 |
| Iron formate | | 0.5 | 0.5 | |
| Iron oxalate | | | | 0.5 |
| Dipentaerythritol | | 1 | | |
| Tripentaerythritol | | | 1 | 1 |

TABLE 4
Tensile stress at break and tensile strain at break of the
molding compositions produced without premix, prior to and
after heat-aging at 180 and 200° C.

| | Comp. | Inv. | Inv. | Inv. |
|---|---|---|---|---|
| | ex. 2 | ex. 2 | ex. 3 | ex. 4 |
| Tensile stress at break prior | 180 | 185 | 181 | 182 |
| to heat-aging [MPa] | | | | |
| Tensile strain at break prior | 3.8 | 3.4 | 3.5 | 3.8 |
| to heat-aging [%] | | | | |
| Tensile stress at break after | 164 | 198 | 200 | 204 |
| 1008 h at 180° C. [MPa] | | | | |
| Tensile strain at break after | 1.9 | 2.7 | 2.8 | 3 |
| 1008 h at 180° C. [%] | | | | |
| Tensile stress at break after | 149 | 200 | 196 | 209 |
| 2016 h at 180° C. [MPa] | | | | |
| Tensile strain at break after | 1.7 | 2.8 | 1.8 | 3.2 |
| 2016 h at 180° C. [%] | | | | |
| Tensile stress at break after | 144 | 202 | 199 | 201 |
| 3024 h at 180° C. [MPa] | | | | |
| Tensile stress at break after | 1.5 | 2.7 | 2.6 | 2.9 |
| 3024 h at 180° C. [MPa] | | | | |
| Tensile stress at break after | 138 | 210 | 213 | 214 |
| 1008 h at 200° C. [MPa] | | | | |
| Tensile strain at break after | 1.4 | 2.9 | 3 | 3.1 |
| 1008 h at 200° C. [%] | | | | |
| Tensile stress at break after | 83 | 197 | 192 | 203 |
| 2016 h at 200° C. [MPa] | | | | |
| Tensile strain at break after | 0.9 | 2.5 | 2.4 | 2.8 |
| 2016 h at 200° C. [%] | | | | |
| Tensile stress at break after | 15 | 160 | 154 | 146 |
| 3024 h at 200° C. [MPa] | | | | |
| Tensile strain at break after | 0.3 | 1.8 | 1.7 | 1.5 |
| 3024 h at 200° C. [%] | | | | |

Materials Used:

PA6 A: nylon-6, linear with a relative solution viscosity of 4.0 for a 1% solution in m-cresol

PA6 B: nylon-6, linear with a relative solution viscosity of 2.9 for a 1% solution in m-cresol

Montan ester wax, e.g., Licowax® E from Clariant GmbH

Glass fibers, e.g. CS7928 from Lanxess Deutschland GmbH

Potassium bromide, d₉₉<70 μm

Copper(I) iodide, (d₉₉<70 μm

Dipentaerythritol, CAS No.: 126-58-9, e.g. Di-Penta 93 from Perstorp Service GmbH

Tripentaerythritol, CAS No: 78-24-0, e.g. Sigma-Aldrich Co. LLC
Iron oxalate, e,g,. iron(II) oxalate dihydrate from VWR GmbH, Langenfeld Germany, subsidiary company of VWR International, A-1150 Vienna

What is claimed is:

1. A substance mixture comprising at least one salt of metal cations and of thermally activatable reducing anions and of at least one polyol, with the proviso that anions considered to be thermally activatable reducing anions are those which at temperatures of 100 to 450° C. enter into reactions with a normal potential at 25° C. relative to the standard hydrogen electrode of less than 0 V with adequate reaction rate, where the expression adequate reaction rates means reaction of at least 10 mol % of the thermally activatable anion over a period of one hour, and the polyols to be used are organic molecules having at least two hydroxy groups per molecule, and iron is used as metal cation, and formate or oxalate is used as thermally reducing anion.

2. The substance mixture as claimed in claim 1, characterized in that salt used comprises at least one from the group of iron formate and iron oxalate, preferably iron formate.

3. The substance mixture as claimed in claim 1 or 2, characterized in that polyols are used from the group of glycerol, trimethylolpropane, 2,3-di(2′-hydroxyethyl)-cyclohexan-1-ol, hexane-1,2,6-triol, 1,1,1-tris(hydroxymethyl)ethane, 3-(2′-hydroxyethoxy)propane1,2-diol, 3-(2′-hydroxypropoxy)propane-1,2-diol, 242′-hydroxyethoxy)hexane-1,2-diol, 6-(2′-hydroxypropoxy)hexane-1,2-diol, 1,1,1-tris[(2′-hydroxyethoxy)methyl]ethane, 1,1,1-tris-2′-hydroxypropoxymethylpropane, 1,1,1tris(4′-hydroxyphenyl)ethane, 1,1,1tris(hydroxy-phenyl)propane, 1,1,3-tris(dihydroxy-3-methylphenyl)propane, 1,1,4-tris(dihydroxy-phenyl)butane, 1,1,5-tris(hydroxyphenyl)-3-methylpentane, ditrimethylolpropane, ethoxylates and propoxylates of trimethylolpropane, or from the group of D-mannitol, D-scurbitol, dulcitol, arabitol, inositol, xylitol, talitol, allitol, altritol, adonitol, erythritol, threitol, pentaerythritol, dipentaerythritol, and tripentaerythritol, or else polyols from the group of the monosaccharides, in particular mannose, glucose, galactose, fructose, D-xylose, arabinose, D-idose, D-erythrose, D-threose, D-ribose, D-lyxose, D-allose, D-altrose, D-gulose, D-talose, D-ribulose, D-erythrulose, D-xylulose, D-psicose, D-sorbose, D-tagatose, D-gluconic acid, D-saccharic acid, D-mannosaccharic acid, mucic acid, D-glucuronic acid, D-mannonic acid, ascorbic acid, D-glucosamine, D-galactosamine, or from the groups of the oligomeric or polymeric saccharides, in particular cyclodextrins, sucrose, lactose, trehalose, raffinose maltose, starch (amylose, amylopectin), pectins, chitin, glycogen, inulin, hemicellulose or cellulose, or else oligomeric or polymeric polyols where these are not from the saccharides group.

4. The substance mixture as claimed in claim 3, characterized in that at least one polyol is used from the group of pentaerythritol, dipentaerythritol, tripentaerythritol, ditrimethylolpropane, and ethylene-vinyl alcohol copolymers, preferably dipentaerythritol or tripentaerythritol, particularly preferably tripentaerythritol.

5. The substance mixture as claimed in any of claims 1 to 4, characterized in that this comprises iron formate and dipentaerythritol and/or tripentaerythritol, preferably iron formate and dipentaerythritol or iron formate and tripentaerythritol, particularly preferably iron formate and dipentaerythritol or iron formate and tripentaerythritol.

6. The substance mixture as claimed in any of claims 1 to 4, characterized in that this comprises iron oxalate and dipentaerythritol and/or tripentaerythritol, preferably iron oxalate and dipentaerythritol or iron oxalate and tripentaerythritol, particularly preferably iron oxalate and dipentaerythritol or iron oxalate and tripentaerythritol.

7. The use of the substance mixtures as claimed in any of claims 1 to 6 for prevention of thermooxidative degradation and/or photooxidative degradation of thermoplastic molding compositions or fibers, foils, or moldings to be produced therefrom.

8. A thermoplastic molding composition comprising a substance mixture as claimed in any of claims 1 to 6.

9. The thermoplastic molding composition as claimed in claim 8, comprising
(1) from 10 to 99.75% by weight of a thermoplastic polymer or a combination of various thermoplastic polymers,
(2) from 0.05 to 10% by weight of at least one salt of metal cations and thermally activatable reducing anions,
(3) from 0.1 to 10% by weight of one or more polyols, and
(4) from 0.1 to 70% by weight of other ingredients, where the entirety of all of the percentages by weight always gives 100% by weight,
with the proviso that anions considered to be thermally activatable reducing anions are those which at temperatures of 100 to 450° C. enter into reactions with a normal potential at 25° C. relative to the standard hydrogen electrode of less than 0 V with adequate reaction rate, where the expression adequate reaction rates means reaction of at least 10 mol % of the thermally activatable anion over a period of one hour, and the polyols to be used are organic molecules having at least two hydroxy groups per molecule, and iron is used as metal cation, and formate or oxalate is used as thermally reducing anion.

10. The thermoplastic molding composition as claimed in claim 9, characterized in that at least one salt from the group of iron formate and iron oxalate is used as component (2).

11. The thermoplastic molding composition as claimed in any of claims 8 to 10, characterized in that component (3) used comprises polyols whose molecular structure has more than three hydroxy groups, preferably dipentaerythritol and/or tripentaerythritol, particularly preferably tripentaerythritol.

12. The thermoplastic molding composition as claimed in any of claims 11, characterized in that component (3) used comprises polyester polyols, polyether polyols, phenol-formaldehyde resins, polyvinyl alcohol, ethylene-vinyl alcohol copolymers, or terpolymers of ethylene, of vinyl alcohol, and also of another compound having at least one double bond, preferably more than one double bond.

13. The thermoplastic molding composition as claimed in any of claims 8 to 12, characterized in that this comprises, as component (1), aliphatic or semiaromatic polyamides, preferably polyamides produced from one or more of the monomers ε-caprolactam, adipic acid, terephthalic acid, hexamethylenediamine, tetramethylenediamine, or 2-methylpentane-1,5-diamine, particularly preferably PA6, PA66, or a copolyamide of PA6 or PA66.

14. A process for the production of thermoplastic molding compositions as claimed in any of claims 8 to 13, characterized in that the components required for this purpose, preferably the components (1) to (4), are mixed in corresponding proportions by weight, preferably at a temperature of from 220 to 400° C., particularly preferably by combining the components, or by a mixing, kneading, compounding, extrusion, or rolling process.

15. The process as claimed in claim 14, characterized in that in a first step component (2) is premixed with a thermoplastic polymer, the premixture is heated to a temperature above the reaction temperature of component (2), and then the premixture is mixed with the other components of the thermoplastic molding composition 16. A fiber, foil, or molding, characterized in that these are obtained by injection molding, extrusion, or blow molding of the thermoplastic molding compositions as claimed in claims 8 to 13.

16. The use of the fibers, foils, or moldings as claimed in claim 16 for the production of items for the electrical, electronics, telecommunications, information-technology, solar, or computer industry, for the household, for sports, for medical applications, or for the consumer-electronics industry, particularly preferably for motor vehicles, very particularly preferably for the engine compartment of motor vehicles.

17. A process for the reduction of photooxidative and/or thermooxidative degradation of thermoplastic molding compositions, comprising at least one thermoplastic polymer, or of foils, fibers, or moldings to be produced therefrom, characterized in that the substance mixture as claimed in any of claims 1 to 6 is added to the thermoplastic polymer.
